(19) United States
(12) Patent Application Publication
(10) Pub. No.: US 2006/0218435 A1
(43) Pub. Date: Sep. 28, 2006

(54) Method and system for a consumer oriented backup

(75) Inventors: Catharine van Ingen, Berkeley, CA (US); Dan Teodosiu, Bellevue, WA (US); Brian T. Berkowitz, Seattle, WA (US); Nikhil R. Joshi, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/090,586

(22) Filed: Mar. 24, 2005

(51) Int. Cl. G06F 11/00

(52) U.S. Cl. 714/6

(57) ABSTRACT

Generally described, embodiments of the present invention provide a system and method for determining what files of a consumer computer should have protection copies included in a backup and what files should be excluded from the backup. Additionally, embodiments of the present invention provide a method and system for recovering files and/or directories from multiple types of temporal versions, such as backup copies and total copies, and also provide the ability to recover from either local temporal versions or remote temporal versions. Still further, embodiments of the present invention provide the ability to only create a protection copy for a portion of a file that has changed since a previous protection copy of a file was created and stored.

### FIELD OF THE INVENTION

In general, the present invention relates to data protection and data protection systems and, in particular, to a system, method, and apparatus for determining what data to protect, controlling the protection, optimizing the protection, and providing recovery of data from multiple sources.

### BACKGROUND

A common problem with end user or consumer computers is creating a copy (referred to herein as a “protection copy”) of items of data, such as files, so that those items can be recovered if destroyed. For ease of explanation, the examples and discussion provided herein will refer to files instead of data generally. However, as will be appreciated by one of ordinary skill in the relevant art, the examples and embodiments described herein may be used with any type of data stored on a computer and the use of files is not to be considered limiting.

Consumers follow several different data protection techniques in an effort to create protection copies of files. Those techniques vary from not generating protection copies at all to creating, on an ad hoc basis, protection copies of all data items stored on the consumer's computer. Additionally, there are many data protection programs that may be used to assist a consumer in creating protection copies of files stored on the consumer's computer.

Typically, protection copies of files are stored internally within the consumer computer at a specified location on the hard drive, stored on removable media (e.g., Compact Disk (“CD), Digital Versatile Disk (“DVD”), removable hard disk, etc.), stored on a local networked backup computer or server, or stored at a remote storage location. However, each of these techniques inherently has the same problems. For example, regardless of the data protection technique used, it must be determined what files on a consumer computer should be protected and how to efficiently create protection copies of the selected files.

Files can be generally divided into two categories--non-user-specific files, and user-specific files. Non-user-specific files make up a large portion of the data stored on a consumer computer and include operating system files, application executables, etc. User-specific files are data that is generated by a consumer and/or specific to the consumer. Such files vary greatly in quantity and type and may include documents, templates, images, videos, database files, settings, etc.

Non-user-specific files can often be recovered from sources other than a protection copy, such as from operating system disks or application installation and/or distribution disks. Because non-user-specific files may typically be restored from sources other than a protection copy and such data is often large, it is desirable to be able to exclude non-user-specific files from protection and only protect user-specific files. Excluding non-user-specific files reduces the overall size and number of generated data protection copies that must be stored the backup and the time incurred in creating the protection copies. Additionally, utilizing application installation/distribution disks to recover application files (i.e., non-user-specific files) is often more reliable than attempting to recover application files from protection copies.

However, while it is simple to describe the classification of files on a consumer computer as either user-specific or non-user-specific, determining which classification a file actually belongs to is much more difficult. For example, user-specific files and non-user-specific files are often located in the same directory and user-specific files may be identified by a common, non-user-specific name. Existing data protection techniques do not provide an efficient way for determining what files should be protected (e.g., user-specific data) and what files should be excluded from protection (e.g., non-user-specific data) and often leave the determination up to the consumer. Requiring a consumer to determine what files should be included/excluded from protection may result in protection copies not be created for user-specific files because the consumer failed to identify the data as needing protection. Additionally, non-user-specific files may be improperly protected, thereby wasting valuable storage space.

Another drawback with existing data protection techniques is that they do not integrate with other data protection techniques when a consumer needs to restore files. In particular, if a consumer needs to restore a file(s) that may be protected at different points-in-time using different techniques (e.g., local backups and remote backups), existing data protection systems do not provide the consumer with an integrated view of how the file(s) can be recovered from the different sources. For example, if a consumer has created a protection copy of a file that is stored internally on the user's computer and also created a protection copy that is stored locally on a CD, the consumer must independently select how the file is to be recovered and independently know of each option and which is more recent.

Accordingly, there is a need for a system and method that are capable of determining what files should be protected and what files should be excluded from protection. Additionally, it would be desirable for such a system to provide a consumer with the ability to include and/or exclude additional files. Still further, a need exists for a system and method that provide the ability to only create a protection copy for a portion of a file that has changed from a previous protection copy of the file, yet still provide the ability for the entire file to be recovered. Additionally, a system and method for allowing a user to recover data from multiple backup sources in an efficient manner are also desirable.

### SUMMARY

Generally described, embodiments of the present invention provide a system and method for determining what files stored on a consumer computer should be included in a backup and what files should be excluded. Additionally, embodiments of the present invention provide a method and system for recovering files and/or directories from multiple types of temporal versions, such as backup copies and total copies, and also provide the ability to recover from either local temporal versions or remote temporal versions. Still further, embodiments of the present invention provide the ability to only backup a portion of a file that has changed since a previous backup, yet still provides the ability to recover the entire file. For example, although a large Personal Folders (“.PST”) file may be updated daily as new e-mail messages are received, only a small fraction of the file changes. If incremental backups are performed on a daily basis, significant space savings may be achieved by only backing up the changed portions of the .PST file.

According to one aspect of the present invention, a method for identifying files that are to be included in a backup copy is provided. The method identifies a file and determines, based on a file extension of the identified file, if the identified file is to be excluded from a backup copy. If it is determined that the identified file is not to be excluded based on the file extension, the method determines, based on a file location of the identified file, if the identified file is to excluded from the backup copy. If it is determined that the identified file is not to be excluded based on the file location, the file is included in the backup copy.

In accordance with another aspect of the present invention, a computer system having a computer-readable medium including a computer-executable program therein for performing the method of creating a protection copy of a chunk of a file, wherein a protection copy of the file has previously been created, is provided. The computer system identifies a file for which a protection copy is to be created and partitions the identified file into a plurality of chunks. Subsequent to partitioning the file into chunks, the computer system determines if a chunk matches a previously stored protection copy of a chunk If it is determined that a chunk does not have a matching protection copy of a chunk, a protection copy of the chunk is created and a chunk assembly list is generated.

In accordance with still another aspect of the present invention, a user backup system having a remote storage location, a computer with a nonremovable storage medium and a removable storage medium is provided, wherein the system performs a method for restoring a file. The method identifies a plurality of temporal versions that have been previously created for the file to be restored, wherein a first temporal version is a local temporal version and wherein a second temporal version is a remote temporal version. A list is generated that includes an identification of a local temporal version of the file and an identification of a remote temporal version of the file. A selection of one of the identified temporal versions is received and, in response, the system obtains the temporal version associated with the selected identified temporal version and recovers the file.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an example computing device that is arranged in accordance with an embodiment of the present invention;

FIGS. 2A and 2B illustrate block diagrams of a directory structure containing both user-specific files and non-user-specific files, in accordance with an embodiment of the present invention;

FIG. 3A illustrates a flow diagram of a data protection system for creating a temporal version containing protection copies of files stored on a consumer computer so that the files can be later recovered if necessary, in accordance with an embodiment of the present invention;

FIG. 3B is a block diagram illustrating the different locations at which temporal versions may be maintained and examples of the different types of temporal versions, in accordance with an embodiment of the present invention;

FIG. 4 is a flow diagram of a backup identification routine for identifying files that are to have protection copies generated and included in a backup copy, in accordance with an embodiment of the present invention;

FIG. 5 is a flow diagram of a heuristic subroutine, in accordance with an embodiment of the present invention;

FIG. 6A is a backup routine for creating a backing copy for files identified in the backup identification routine, in accordance with an embodiment of the present invention;

FIG. 6B illustrates a flow diagram of a chunk file subroutine for chunking files that are to be backed up, in accordance with an embodiment of the present invention;

FIG. 7 illustrates a flow diagram of a system for recovering files for which temporal versions containing protection copies of those files had been created, in accordance with an embodiment of the present invention;

FIG. 8 is a pictorial diagram of a collective recovery list identifying different temporal versions of the file MY WORD for which recovery has been requested, in accordance with an embodiment of the present invention;

FIG. 9 is a flow diagram of a restore routine for restoring files from protection copies contained in a temporal versions, in accordance with an embodiment of the present invention;

FIG. 10 is a flow diagram of a recovery list subroutine for generating a recovery list identifying different protection copies of a file that is to be recovered, in accordance with an embodiment of the present invention; and

FIG. 11 is a block diagram illustrating a chunk restore subroutine for restoring files that have been saved in chunks, in accordance with an embodiment of the present invention.

### DETAILED DESCRIPTION

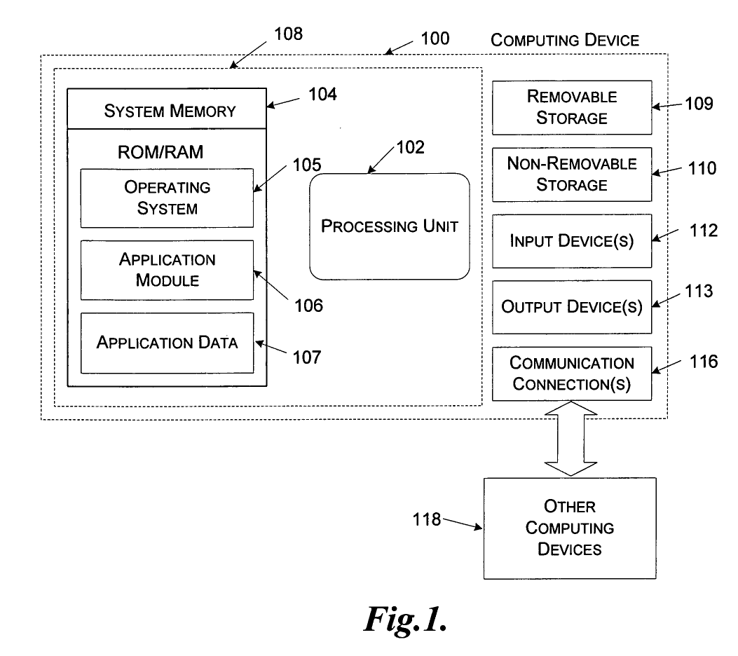

FIG. 1 is a block diagram of an example computing device that is arranged in accordance with an embodiment of the present invention. In a basic configuration, computing device 100 typically includes at least one processing unit 102 and system memory 104. Depending on the exact configuration and type of computing device, system memory 104 may be volatile—such as Random Access Memory (“RAM”); nonvolatile, such as Read Only Memory (“ROM”); flash memory; etc., or some combination of the two. System memory 104 typically includes an operating system 105, one or more application modules 106, and may include application data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and nonremovable storage 110. Computer storage media may include volatile and nonvolatile, removable and nonremovable media implemented in any method or technology for storage of information, such as computer readable instructions, data structures, program modules or other data. System memory 104, removable storage 109 and nonremovable storage 110 are all examples of computer storage media. Computer storage media includes, but is not limited to, RAM, ROM, Electrically Erasable Programmable Read Only Memory (“EEPROM”), flash memory or other memory technology, CD-ROM, DVD or other optical storage, magnetic cassettes, magnetic tape, magnetic disk storage or other magnetic storage devices, or any other medium that can be used to store the desired information and that can be accessed by computing device 100. Any such computer storage media may be part of device 100. Computing device 100 may also have input device(s) 112, such as keyboard, mouse, pen, voice input device, touch input device, etc. Output device(s) 114, such as a display, speakers, printer, etc., may also be included. All these devices are known in the art and need not be discussed at length here.

Computing device 100 may also contain communications connection(s) 116 that allow the device to communicate with other computing devices 118, such as over a network. Communications connection(s) 116 is an example of communication media. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, Radio Frequency (“RF”), microwave, satellite, infrared, and other wireless media. The term computer readable media as used herein includes both storage media and communication media.

Various types of data may be stored in system memory 104, removable storage 109, and nonremovable storage 110. In one example, non-user-specific data, such as application executables, may be stored on nonremovable storage 110 and user-specific data, such as documents and images, may be stored on nonremovable storage 110. Generally, data—both user-specific and non-user-specific—is stored on nonremovable storage 110 according to some type of organizational structure, such as a directory structure.

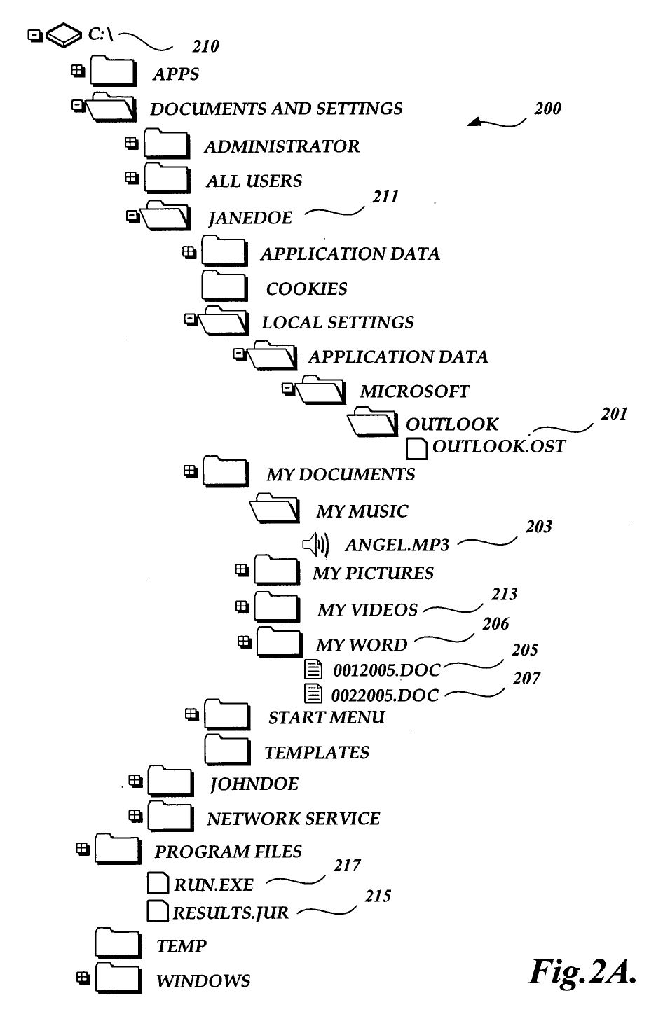

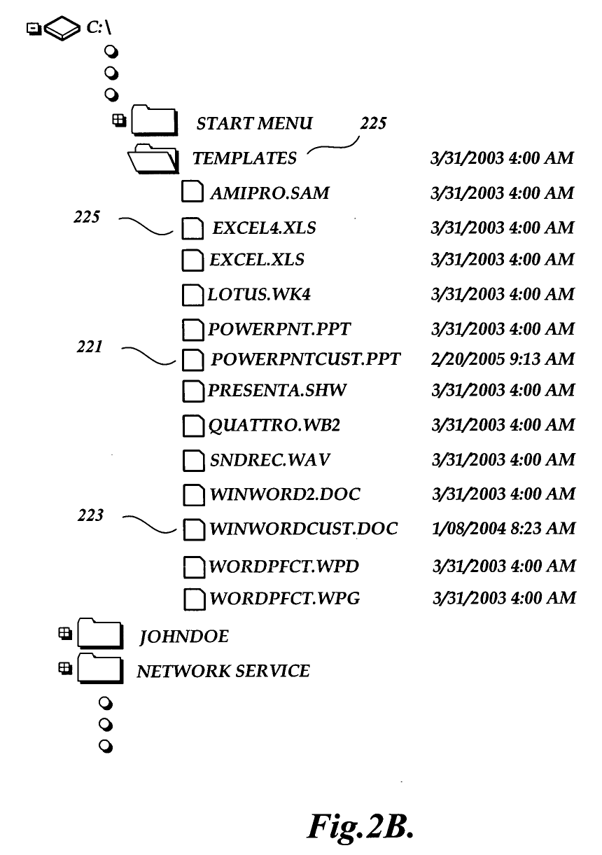

FIGS. 2A and 2B illustrate block diagrams of a directory structure containing both user-specific files and non-user-specific files, in accordance with an embodiment of the present invention. As noted above, for ease of explanation, the examples provided herein will refer to files, such as user-specific files and non-user-specific files. However, as will be appreciated by one of ordinary skill in the relevant art, the embodiments described herein may be used with any type of data stored on a computer and the use of files is intended to encompass all types of data. Additionally, while the embodiments described herein will refer to creating protection copies of files stored on a consumer computer, it will be appreciated that the invention is not limited to consumer computers and may be utilized with any type of computing device.

FIG. 2A illustrates a directory structure 200 for a directory listing of data contained in volume located on nonremovable storage of a consumer computer, illustrated by C:\210. As can be seen from the directory structure 200, user-specific files may be located in many different directories within a volume on the nonremovable storage and located on different volumes (not shown) of nonremovable storage of a consumer computer. For example, OUTLOOK.OST 201, a user-specific file, is located in the directory having a path of C:\DOCUMENTS AND SETTINGS\JANEDOE\LOCAL SETTINGS\APPLICATIONDATA\MICROSOFT\OUTLOOK. The user-specific file ANGEL.MP3 203 is located in the directory having a file path of C:\DOCUMENTS AND SETTINGS\JANEDOE\MY DOCUMENTS\MY MUSIC. Two user-specific files 0012005.DOC 205 and 0022005.DOC 207 are located in a directory having a path of C:\DOCUMENTS AND SETTINGS\JANEDOE\MY DOCUMENTS\MY WORD. While each of the user-specific files mentioned above is contained within the JaneDoe folder 211, user-specific files may also be located in directories other than a user's directory. For example, the user-specific file of RESULTS.JUR 215 may be included in the directory having a path of C:\PROGRAM FILES. Additionally, non-user-specific files, such as RUN.EXE 217, may also be included in the same directory as user-specific files.

For example, referring to FIG. 2B, user-specific template files, such as POWERPNTCUST.PPT 221 and WINWORDCUST.doc 223, may be included in a TEMPLATES FOLDER 225, along with several other template files that are non-user-specific. A collection of both non-user-specific template files, such as EXCEL4.XLS 225, and user-specific files, such as POWERPNTCUST.PPT 221, in the same folder of a directory makes distinguishing between user-specific and non-user-specific files difficult.

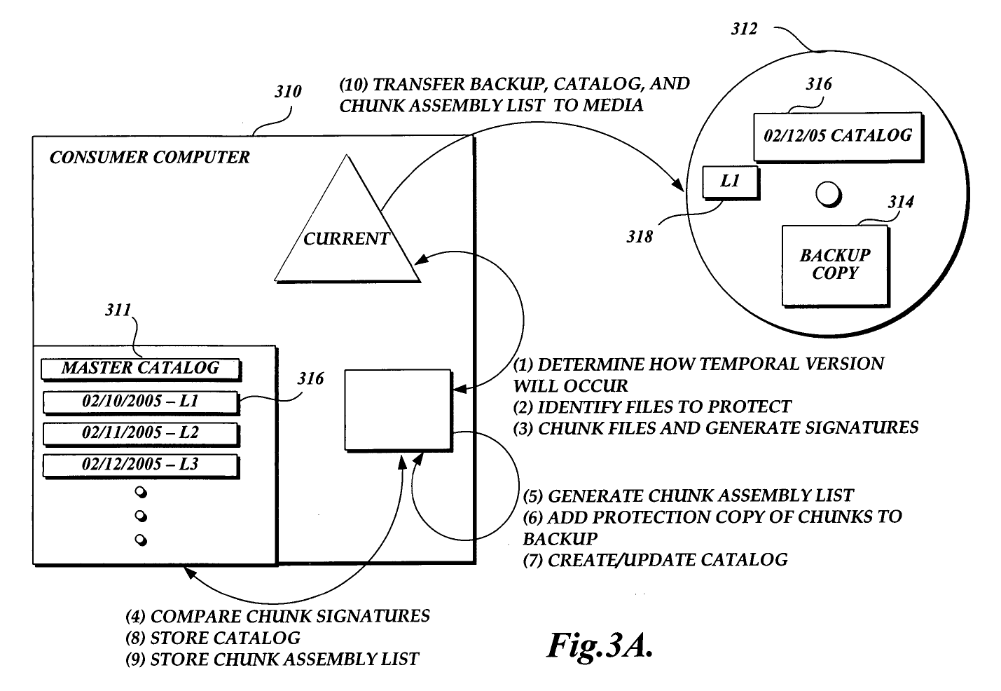

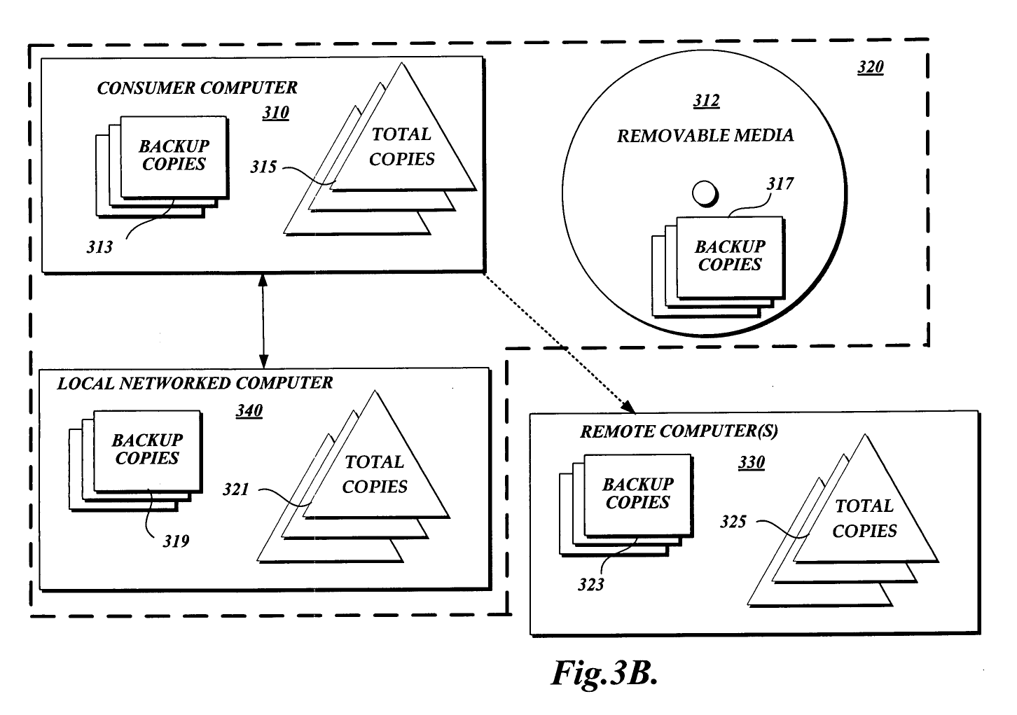

FIG. 3A illustrates a flow diagram of a data protection system for creating a temporal version containing protection copies of files stored on a consumer computer so that the files can be later recovered, if necessary, in accordance with an embodiment of the present invention. At an initial point, an identification of how the creation of a “temporal version” will occur is received. A “temporal version,” as referred to herein, is a collection of one or more protection copies of files (user-specific and/or non-user-specific) created at a point-in-time. As discussed in more detail below, a temporal version may be, for example, a total copy (discussed and defined below), or a backup copy (discussed and defined below). Identification of how a temporal version is to be created may be received from an automatic data protection routine that is scheduled, provided by a consumer, or obtained by other means. Referring to FIG. 3B, temporal versions may be created in different forms and stored at different locations.

In particular, a temporal version may be created in the form of a “total copy” 315, 321, 325 or a “backup copy” 313, 317, 319, 323. A “total copy,” as referred to herein, is a temporal version that contains protection copies of the full contents of a volume (both user-specific files and non-user-specific files) of nonremovable storage 110 (FIG. 1) created at a point-in-time. A “backup copy,” as referred to herein, is a temporal version that contains protection copies of a selected set of user-specific files from a volume created at a point-in-time. A selected set of user-specific files may be a single user-specific file, a plurality of user-specific files, or all user-specific files of a volume.

Additionally, a backup copy may be a “full backup copy,” an “incremental backup copy,” or a “chunked incremental backup copy.” A “full backup copy” contains a protection copy of all selected user-specific files. An “incremental backup copy” contains protection copies of only those selected user-specific files that have changed since the previous backup copy was created. A “chunked incremental backup copy” contains protection copies of only those changed chunks of files that have changed since the last backup. Except where identified specifically, full backup copy, incremental backup copy, and chunked incremental backup copy will be referred to generally as backup copy.

Regarding location, both backup copies 313, 317, 319, 323 and total copies 315, 321, 325 may be maintained locally 320 and/or remotely 330. As discussed herein, a temporal version (either a total copy or a backup copy) is considered to be “local” if it is geographically near the consumer computer. For example, if a temporal version is stored on the consumer computer it is local. Likewise, if a temporal version is stored on another computer 340 networked to the consumer computer 310 that is located in the same building as the consumer computer 310, the temporal version is considered local. Additionally, if a temporal version is stored on removable media 312 that is maintained geographically near the consumer computer 310 (e.g., in the same building), it is local. In contrast, the temporal version is “remote” if it is geographically distinct from the consumer computer 310. For example, if a temporal version is stored on a computer that is in another building (e.g., an off-site or third party data storage facility), it is remote. Likewise, if the temporal version is stored on removable media, such as a DVD, that is stored off-site (e.g., in a bank vault), it is considered remote.

Generally, due to their size, total copies are maintained locally on the consumer computer, locally on a networked computer, or remotely. Backup copies are generally maintained locally on removable media and may be physically and/or logically separated from the consumer computer for additional safety. While these are the general uses of total copies and backup copies, they are not intended to be limiting. For example, a backup copy may be stored on the consumer computer, on a local networked computer, on removable media, or maintained remotely (on a computer or removable media).

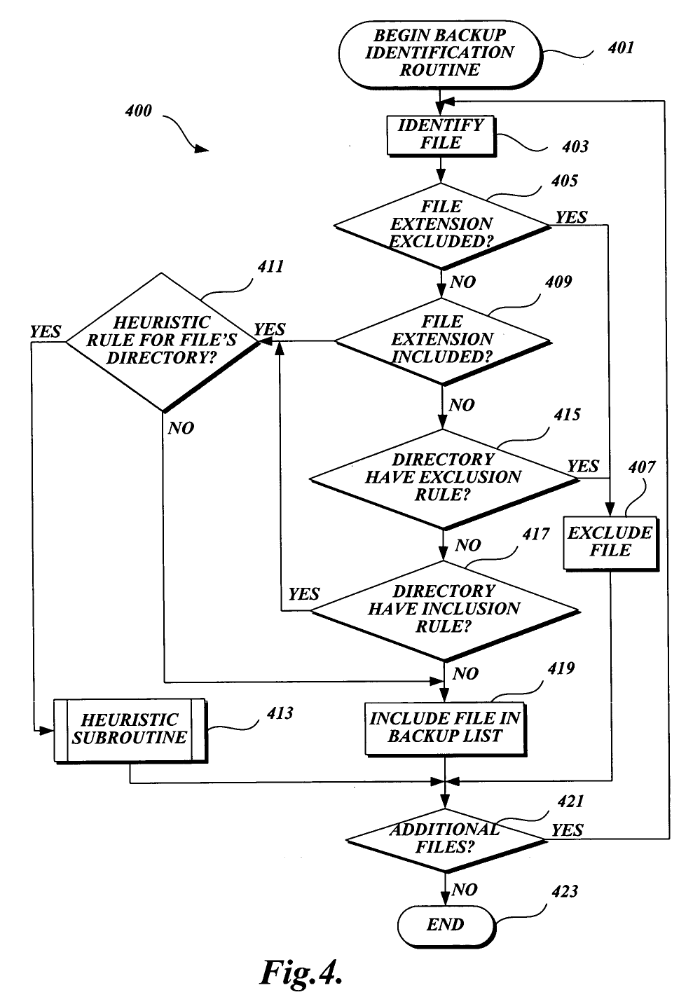

Returning now to FIG. 3A, if the temporal version is to be in the form of a backup copy, the system then identifies what files are to have protection copies generated and included in the backup. As mentioned above and described in more detail below with respect to FIGS. 4-6, the system may filter files stored on a consumer computer 310 to identify those that are to have protection copies included in a backup copy and those that are to be excluded from a backup copy. Because backup copies are generally stored on removable media, such as a CD, it is beneficial to limit the number of protection copies that are included in the backup in order to reduce the amount of space consumed by the backup.

In one embodiment, the system identifies non-user-specific files and excludes those files from the backup. Additionally, for user-specific files that are identified as to be included in the backup, a user may specify file types that are to be excluded. For example, if a consumer has a large amount of .mp3 files stored on the consumer computer, which files are identified as user-specific files but has CD copies of a majority or all of those files, the consumer may specify not to include protection copies of music files (or .mp3) files in a backup copy. In one embodiment, a user may simply indicate that he or she does not want to protect “music,” and the system translates that request into specific rules that exclude audio file types (e.g., .wma, .mp3, .mp4, .asx, etc.) from the backup copy.

As mentioned above, the backup copy may be a full backup copy containing protection copies of all identified files, an incremental backup copy containing protection copies of files that have changed since the previous backup copy, or a chunked incremental backup copy including protection copies of chunks of files that have changed since the previous backup. For a full backup copy, a protection copy of each identified user-specific file is generated and added to the backup copy and the backup copy is stored. In one embodiment, the protection copy is created from the actual user-specific file. In an alternative embodiment, the protection copy is generated from a total copy. Additionally, a backup catalog 316 identifying the contents (i.e., protection copies) of the backup copy is generated and maintained on the consumer computer 310.

An incremental backup copy contains a protection copy of for each identified user-specific file that has changed since the previous backup copy. In generating an incremental backup copy, the identified user-specific files are compared with the protection copies of those files included in the previous backup copy. For example, the last modified time of each file may be compared with the modification time of the corresponding protection copy stored in the previous backup copy and, if the last modified time has changed, the file has changed and thus a protection copy is added to the new backup copy. Any type of comparison may be used for determining if files have changed and comparing the last modified time is provided only as an example. Similar to the full backup copy, a backup catalog 316 is maintained on the consumer computer 310.

Chunking of files is described in detail in copending U.S. patent applications Ser. No. 10/825,735, titled “Efficient Algorithm and Protocol for Remote Differential Compression,” filed on Apr. 15, 2004, which is incorporated herein by reference; Ser. No. 10/844,895, titled “Efficient Chunking Algorithm,” filed on May 13, 2004; Ser. No. 10/844,907, titled “Efficient Algorithm and Protocol for Remote Differential Compression on a Local Device,” filed on May 13, 2004; and Ser. No. 10/844,906, titled “Efficient Algorithm and Protocol for Remote Differential Compression on a Remote Device,” filed on May 13, 2004—all of which are incorporated herein by reference. In general, a file is chunked by partitioning the file in a data-dependent fashion using a fingerprinting function that is computed at every byte position in the file. A chunk boundary is determined at positions in the file for which the fingerprinting function satisfies a given condition. Once the file has been chunked, a signature is generated for each chunk. A signature may be generated using any type of hashing algorithm, such as a cryptographically securing hash functions, like the Secure Hash Algorithm (“SHA”).

Once the files have been chunked and chunk signatures generated, those chunk signatures are compared with chunk signatures of previously stored protection copies of chunks. For example, if the file outlook.ost 201 (FIG. 2) was previously chunked and protection copies of those chunks generated and stored in a backup copy, the system chunks the file, generates signatures, and compares the generated signatures with the signatures of the previously stored protection copies of chunks. Such a comparison may be accomplished by comparing chunk signatures stored in a catalog that is maintained on the consumer computer 410. Upon a comparison of the chunk signatures, for each signature that is different than the chunk signatures of protection copies of chunks, a protection copy of the chunk is generated and added to the backup. In addition, for each protection copy of a chunk that is added to a backup copy, the catalog for the backup copy is updated to identify the protection copy of the chunk and a chunk assembly list is updated to identify the location of the protection copy of the chunk.

Additionally, in an embodiment of the present invention, chunks may be compared across files and one protection copy of a chunk may be used to restore multiple files. For example, if a first image file is chunked and all protection copies of all chunks are generated and added to the backup copy and a second image file that is the same as the first image file except for a small change in corner of the image, that file is chunked and those chunks are compared with the chunks if the first image file. Only the chunks that are different will have protection copies created and added to the backup copy. Thus, the same chunk, in conjunction with other chunks, may be used to restore both image files.

Once a backup copy has been created that includes the protection copies of the identified files, protection copies of the changed identified files, or protection copies of chunks of changed identifies files, the backup copy catalog 316 and chunk assembly list (if the backup was a chunked incremental backup) are stored on the consumer computer 410. Next, the backup copy 314, backup copy catalog 316 and chunk assembly list (not shown) are transferred to where they will be maintained, such as removable media 412. Additionally, a label 318 is assigned to the removable media to correlate the media to the backup copy catalog 311 stored on the consumer computer 310. The backup copy catalog 316, both stored on the removable media and stored on the consumer computer, identifies the contents of the backup copy and the location (i.e., the removable media label) of the backup copy. Finally, a master catalog 311 that identifies all protection copies of files in all backup copies is updated by merging the local backup catalog into the master catalog.

FIG. 4 is a flow diagram of a backup identification routine for identifying files that are to have protection copies generated and included in a backup copy, in accordance with an embodiment of the present invention. The backup identification routine 400 begins at block 401, and at block 403, identifies a file located on a volume of a consumer computer. For the identified file, at decision block 405, it is determined if the file, based on the file extension, is to be excluded from the backup. As is well known by one of ordinary skill in the relevant art, files have file extensions identifying the file type. For example, a file might have an extension of .exe, .tmp, .doc, .xls, .ost, .pst, .ppt, etc. Many of the extensions identify a file type that is non-user-specific and thus is excluded from a backup. For example, file extensions of .exe or .tmp identify file types that are non-user-specific. Non-user-specific files are excluded from a backup copy because they can generally be recovered from other sources and consume valuable storage space. If it is determined at decision block 405 that the file identified at block 403 is to be excluded, at block 407, the file is excluded from the backup.

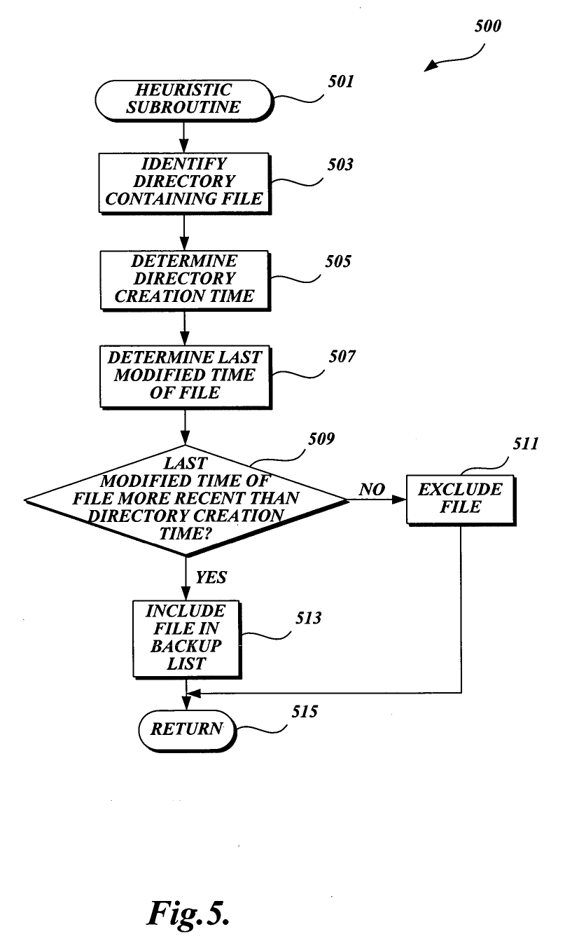

However, if it is determined at decision block 405 that the identified file is not of a type that is to be excluded based on its extension, at decision block 409, a determination is made as to whether the file is of a type, based on its extension, that is to have a protection copy generated and included in a backup copy. File types that are to have protection copies included in a backup copy, based on file extension, are file types that are known to contain user-specific data. Such file types include files with extensions of .doc, .xls, .vsd, .mp3, etc. If it is determined at decision block 409 that the file is a type that is to be included, based on its extension, at decision block 411, a determination is made as to whether a heuristic rule applies to the directory containing the file. For example, if the file identified in block 403 is 0012005.doc 205 (FIG. 2A), the routine 400, upon determining that the file is to have a protection copy included in the backup copy because it has a .doc extension, at decision block 41 1, it is determined if the directory, MY WORD 206, containing the file 0012005.doc 205 has a corresponding heuristic rule. If it is determined that the file's directory has a heuristic rule, a heuristic rule subroutine is performed with respect to that file, as illustrated with respect to subroutine block 413 and described in more detail below with respect to FIG. 5.

Referring back to decision block 409, if it is determined that the file type, based on the extension, is not specifically included in the backup, at decision block 415 a determination is made as to whether the directory containing that file has an exclusion rule excluding the directory from the backup. An exclusion rule may be generated, for example, by a user specifically indicating that files contained in that directory are not to be protected. For example, if the directory contains music files, such as ANGEL.MP3 203 (FIG. 2) and the user indicates that the folder MY MUSIC that contains the music files is not to be included in the backup copy, an exclusion rule is assigned to that directory. In an alternative embodiment, the user may simply be allowed to specify what types of user-specific files are to be excluded. For example, a user may simply specify that music files are to be excluded. The system upon receipt of such an identification translates the request into specific exclusion rules to exclude music type files (e.g., .wma, .mp3, etc.) and potentially directories containing those files.

If it is determined at decision block 415 that the directory containing the file has an exclusion rule, the file is excluded, as illustrated by block 407. However, if it is determined at decision block 415 that the directory containing the file does not have an exclusion rule, at decision block 417, it is determined whether the directory containing the file has an inclusion rule including the file in the backup. Similar to an exclusion rule, an inclusion rule may be assigned to a directory by a user indicating that files in that directory are to be protected. Alternatively, an inclusion rule may be generated in response to a user specifying that files of a particular type are to be protected. If it is determined at decision block 417 that the directory has an inclusion rule, the routine 400 returns to decision block 411 and determines if an heuristic rule applies to the directory, and the routine 400 continues.

However, if it is determined, at decision block 417, that the directory containing the file does not have an inclusion rule, or if it is determined at decision block 411 that the directory does not have a heuristic rule, at block 419, the file identified at block 403 is included in a backup copy list. A backup copy list includes an identification of all files that are to have protection copies generated and included in a backup copy. After the file has been added to the backup copy list, as illustrated by block 419, excluded from the backup, as illustrated by block 407, or upon completion of the heuristic subroutine at block 413, at decision block 421, a determination is made as to whether there are additional files to be processed. If it is determined at decision block 421 that there are additional files to be processed, the routine 400 returns to decision block 405 and continues. However, if it is determined at decision block 421 that there are no additional files to process, the routine 400 completes at block 423.

While FIG. 4 has been described with respect to performing the heuristics determination, at decision block 411, if a file extension is identified as being included (block 409) or if it is determined that the directory containing the file has an inclusion rule (block 417), it will be appreciated that the heuristic subroutine may be omitted. For example, if it is determined at decision block 409 that the file extension is included in the backup, the file may be simply added to the backup copy list and the routine 400 continued. Likewise, if it is determined at decision block 417 that the directory has an inclusion rule, the file contained within that directory may be simply included in the backup copy list and the routine 400 continued.

FIG. 5 is a flow diagram of a heuristic subroutine corresponding to heuristic subroutine block 413, in accordance with an embodiment of the present invention. The heuristic subroutine 500 begins at block 501 and, at block 503, the directory containing the file identified at block 403 (FIG. 4) is identified and at block 505, a directory creation time is determined. In addition, at block 507, a determination is made as to the last modified time of the file identified at block 403 (FIG. 4). At decision block 509, the modification time of the file and the creation time of the directory are compared and if it is determined that the modification time of the file is not more recent than the directory creation time, the file is excluded from the backup copy list, as illustrated by block 511. Determining that a file has the same last modification time as the creation time of the directory identifies the file as being a non-user-specific file, because it was created at the same time as creation of the directory containing that file. However, if it is determined at decision block 509 that the last modified time of the file is more recent than the directory creation time, thereby identifying that it is a user-specific file, the file is included in the backup copy list, as illustrated by block 513.

Once a file has been included in the backup copy list at block 513 or excluded from the backup copy list at block 511, the heuristic subroutine 500 returns control to the backup identification routine 400 (FIG. 4), as illustrated by block 515. As will be appreciated by one of ordinary skill in the relevant art, other types of heuristic subroutines may be performed on a file's directory, and the heuristic subroutine 500 described herein is provided for explanation purposes only.

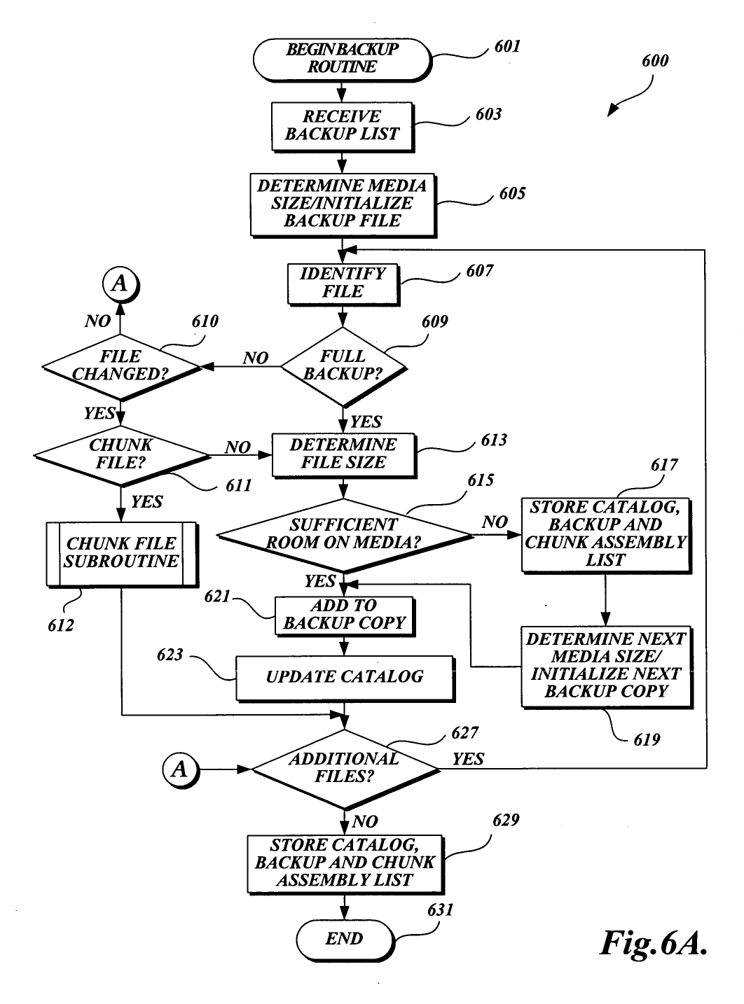

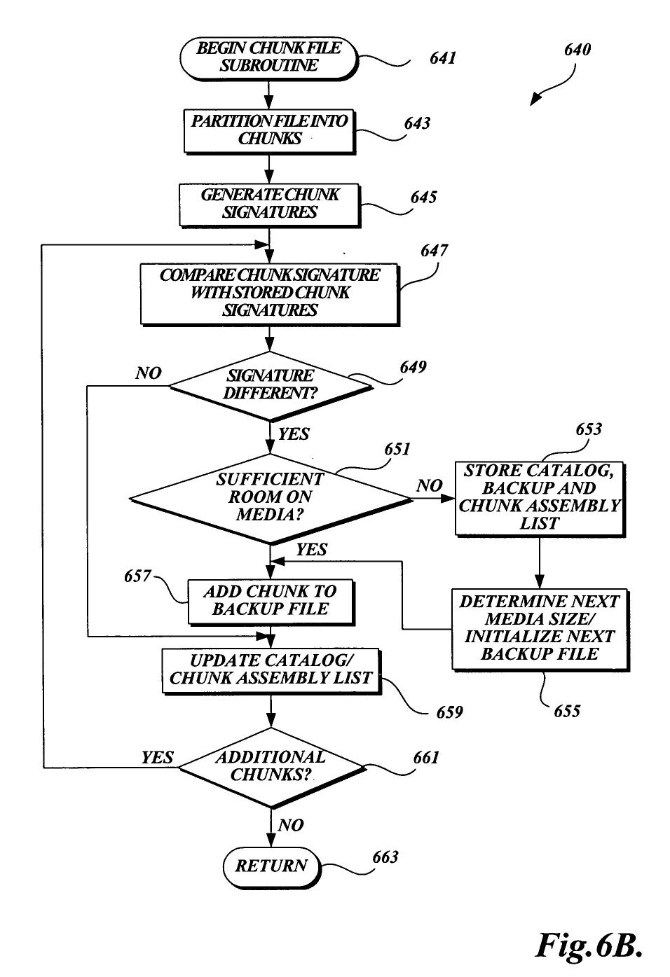

FIG. 6A is a backup routine for creating a backup copy for files identified in the backup identification routine 400 (FIG. 4), in accordance with an embodiment of the present invention. The backup routine 600 begins at block 601, and at block 603 receives the backup copy list generated by the backup identification routine 400. At block 605, a media size where the backup copy will be stored is determined and a backup file is initialized. The media size is dependent upon the type of media onto which the backup copy file will be stored. For example, if the media is removable media in the form of a CD, the media size may be 700 Megabytes. Alternatively, if the media is a local networked computer, the media size may be much larger. However, for backups to large media, such as a local networked computer, the media size may be limited based on scaling of the media formal. Alternatively, a predetermined maximum media size may be specified regardless of the actual media size. Specifying a maximum media size, as will be apparent below, may be used to limit the size of the backup copy.

At block 607 a file included in the backup list is identified and at decision block 609, a determination is made as to whether the backup is to be a full backup. If it is determined that the backup is not a full backup, at decision block 610 it is determined whether the identified file has changed from the protected copy of the file stored in the previous backup copy. As discussed above, a file change may be determined by comparing the last modified time of the file with the last modified time of the protected copy, comparing signatures of the file with signatures of the protected copy, etc.

If it is determined at decision block 610 that the file has not changed, the routine 600 proceeds to decision block 627 and continues as discussed below. However, if it is determined at decision block 610 that the file has changed, at decision block 611 it is determined if the file is to be chunked, depending on whether a chunked incremental backup is desired. If it is determined at decision block 611 that the file is to be chunked, the chunk file subroutine 612 is performed, as described in more detail below with respect to FIG. 6B. However, if it is determined that the file is not to be chunked or if it is determined at decision block 609 that the backup is to be a full backup copy, at block 613, the file size is determined and at decision block 615 a determination is made as to whether there is sufficient room on the media for the backup copy if a protection copy of the identified file is added to the backup copy. If it is determined at decision block 615 that there is not sufficient room on the media, at block 617, the backup copy catalog, backup copy, and chunk assembly list (if exists) are stored. The backup copy catalog, backup copy, and chunk assembly list may be stored on the computing device, stored directly on the media on which it will be maintained, or stored on the computing device and subsequently transferred to the media on which it will be maintained. Additionally, the master catalog may also be updated to include an identification/location of the backup copy and the contents of that backup copy.

At block 619, a media size of the next item of media is determined and a new backup copy is initialized. Similar to determining the media size at block 605, the media size is dependent upon the media itself. Returning to decision block 615, if it is determined that there is sufficient room on the media or after new media has been allocated and a new backup copy initialized (block 619), at block 621, a protection copy of the file is generated and added to the backup copy. Additionally, the backup copy catalog is updated to identify the protection copy of the file as being included in the backup copy being created, as illustrated by block 623.

Once a protection copy of the file has been added to the backup copy and the backup copy catalog updated, at decision block 627, it is determined whether there are additional files included in the received backup list that need to have protection copies generated and included in a backup copy. If it is determined that there are additional files, the routine 600 returns to block 607 and continues. However, if it is determined that there are no additional files, at block 629 the backup copy catalog, backup copy, and chunk assembly list (if exists) are stored. The backup copy catalog, backup copy, and chunk assembly list may be stored on the computing device, stored directly on the media on which it will be maintained, or stored on the computing device and subsequently transferred to the media on which it will be maintained. Additionally, a master catalog may be updated by merging the backup copy catalog into the master catalog. In one embodiment of the present invention, the master catalog is updated once the backup copy, backup copy catalog, and chunk assembly list (if it exists) have been transferred to media.

FIG. 6B illustrates a flow diagram of a chunk file subroutine for chunking files that are to be backed up, in accordance with an embodiment of the present invention. The chunk file subroutine 640 begins at block 641 and, at block 643, the file is partitioned into chunks. Additionally, for each chunk of a file, a chunk signature is generated, as illustrated by block 645. Partitioning files into chucks and generating chunk signatures is discussed in the above incorporated copending applications and will not be discussed herein. The chunk signatures of the file are compared with corresponding chunk signatures of previous protection copies of chunks. Upon comparison, at decision block 649, a determination is made as to whether the signature of a chunk is different from signatures of the protection copies of chunks. If it is determined that the signature is different, i.e., the chunk does not have a corresponding protection copy, at decision block 651, a determination is made as to whether there is sufficient room on the media for the backup file if a protection copy of the chunk is added. If it is determined at decision block 651 that there is not sufficient room on the media, at block 653, the backup copy catalog, backup copy, and chunk assembly list are stored. The backup copy catalog, backup copy, and chunk assembly list may be stored on the computing device, stored directly on the media on which it will be maintained, or stored oh the computing device and subsequently transferred to the media on which it will be maintained. Additionally, the master catalog may also be updated to include an identification/location of the backup copy and the contents of that backup copy.

At block 655, a media size of the next item of media is determined and a new backup copy is initialized. Similar to determining the media size at block 605 (FIG. 6A), the media size is dependent upon the media itself and/or may be limited by a predetermined maximum media size. Returning to decision block 651, if it is determined that there is sufficient room on the media or after new media has been obtained and a new backup copy initialized, at block 657 a protection copy of the chunk is generated and added to the backup copy. Additionally, the catalog is updated to identify the protection copy of the chunk as being located on the backup copy being created, as illustrated by block 659. After the protection copy of the chunk is added to the backup copy at block 657, or if it is determined at decision block 649 that the signature is not different, a chunk assembly list that includes information as to how to restore the file being chunked is updated to include information as to the location of the protection copy of the chunk, also as illustrated by block 659.

At decision block 661 a determination is made as to whether additional chunks of the identified file remain. If it is determined at decision block 661 that additional chunks remain, the routine 640 returns to block 647 and continues. However, if it is determined at decision block 661 that no additional chunks remain, the routine returns control to the backup routine 600 (FIG. 6A), as illustrated by block 663.

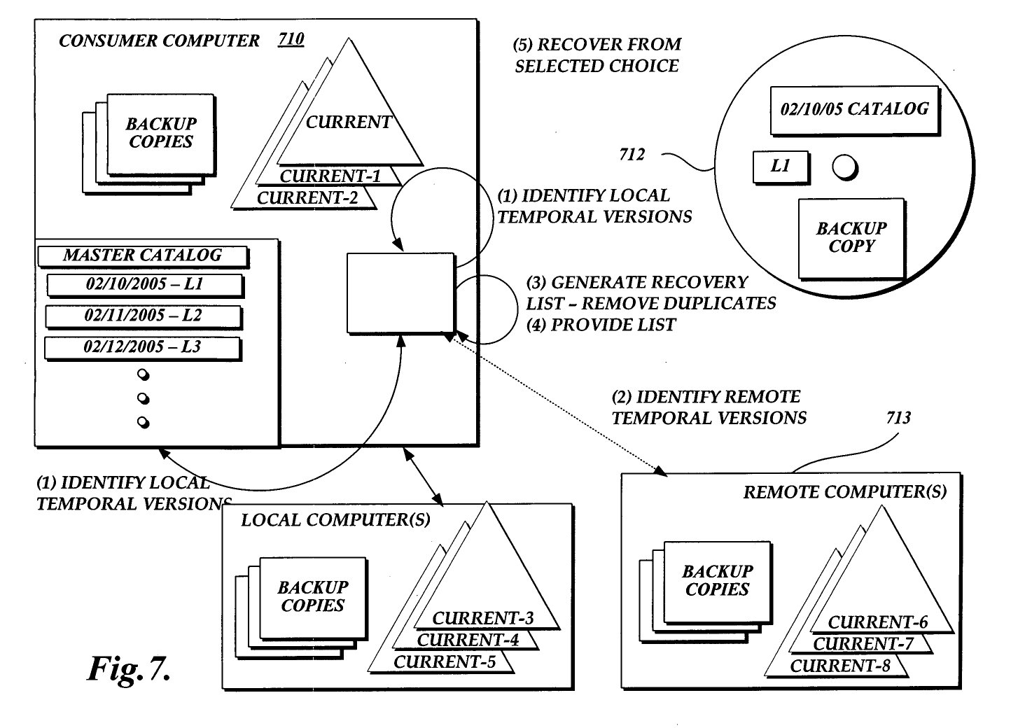

FIG. 7 illustrates a flow diagram of a system for recovering files for which temporal versions containing protection copies of those files had been created, in accordance with an embodiment of the present invention. As discussed above, temporal versions may be created and stored both locally and/or remotely in different forms. For example, a temporal version in the form of a total copy may be stored internally within the consumer computer 710 or stored internally within other local computers 709 networked to the consumer computer 710. Additionally, local backup copies may be created and stored on removable media 712 that is maintained at the same location as the consumer computer 710. Likewise, temporal versions may be created and offloaded to a remote storage site, such as remote storage 713. The remote temporal versions may include backup copies and/or total copies.

Upon identification of a file that is to be recovered, the system identifies all local temporal versions that include a protection copy of the file to be recovered and the different points-in-time for which it may be recovered. For example, if a user requests to recover a particular file, the system may identify that there is a current-i total copy that is maintained locally on the consumer computer 710 that includes a protection copy of the file to be recovered, a current-3 total copy maintained locally on a networked computer that includes a protection copy of the file to be recovered, an L1 backup copy maintained locally on removable media that includes a protection copy of the file to be recovered, an L3 backup copy maintained locally on removable media that includes a protection copy of the file to be recovered, a current-3 total copy maintained at a remote location 713 that includes a protection copy of the file to be recovered, a current-6 total copy maintained at a remote location 713 that includes a protection copy of the file to be recovered, and a current-7 total copy maintained at a remote location 713 that includes a protection copy of the file to be recovered.

Techniques for identifying remote temporal versions for recovery are described in more detail with respect to copending U.S. patent applications Ser. No. 10/937,708, titled “Method, System, and Apparatus for Configuring a Data Protection System,” filed on Sep. 9, 2004; Ser. No. 10/937,204, titled “Method, System, and Apparatus for Creating Saved Searches and Auto Discovery Groups for a Data Protection System,” filed on Sep. 9, 2004; Ser. No. 10/937,061, titled “Method, System, and Apparatus for Translating Logical Information Representative of Physical Data in a Data Protection System,” filed on Sep. 9, 2004; Ser. No. 10/937,060, titled “Method, System, and Apparatus for Providing Resilient Data Transfer in a Data Protection System,” filed on Sep. 9, 2004; Ser. No. 10/937,218, titled “Method, System, and Apparatus for Creating an Architectural Model for Generating Robust and Easy to Manage Data Protection Applications in a Data Protection System,” filed on Sep. 9, 2004; Ser. No. 10/937,650, titled “Method, System, and Apparatus for Providing Alert Synthesis in a Data Protection System,” filed on Sep. 9, 2004; and Ser. No. 10/937,651, titled “Method, System, and Apparatus for Creating an Archive Routine for Protecting Data in a Data Protection System,” and filed on Sep. 9, 2004—all of which are incorporated by reference herein.

Upon identification of the local temporal versions and remote temporal versions that contain a protection copy of a file that is to be recovered, a collective recovery list is generated by compiling each of the recoverable options and removing any duplicates. In an embodiment of the present invention, in removing duplicates, the best choice for recovering the file is the only choice provided in the recovery list. For example, if the same protection copy of a file is contained in a temporal version stored on the user's computer 710 and also contained in a temporal version located locally on removable media, the protection copy contained in the temporal version stored on the user's computer will be identified in the recovery list and the protection copy contained in the temporal version stored on removable media temporal version not identified. The protection copy contained in the locally stored temporal version is identified because it is the easiest to recover.

Upon generation of the recovery list, the list is provided to the consumer, the consumer provides a selection protection copy that is to be recovered, and the system accesses the appropriate temporal version and recovers the selected protection copy. For example, if the user selects a protection copy that is contained in a temporal version with a label of L1 that is stored on removable media 712, the system identifies to the consumer the piece of removable media 712 that is needed to recover the file. Once the consumer provides the removable media, the file is recovered using the protection copy contained in the temporal version Additionally, in some instances, the file to be recovered may span more than one item of removable media or be contained on different types of media (e.g., removable, local, etc.) In such a situation, the system will identify the items of media and, if necessary, request each item of media from the consumer as it is needed in order to recover the file.

While the embodiments described herein discuss recovering a file, it will be appreciated by one of ordinary skill in the relevant art that embodiments of the present invention may be used to recover any number of files, directories, and/or volumes and that the description provided herein is not to be intended as limiting embodiments of the present invention to the recovery of a single file.

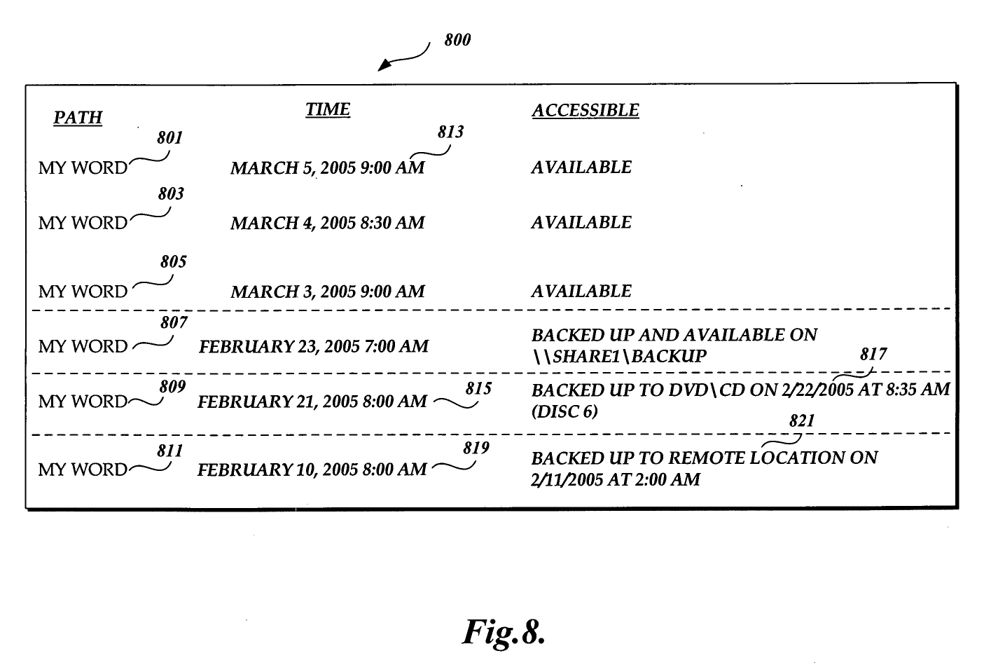

FIG. 8 is a pictorial diagram of a collective recovery list identifying different temporal versions of the file MY WORD for which recovery has been requested, in accordance with an embodiment of the present invention. In particular, the pictorial diagram 800 identifies six temporal versions of the file MY WORD that may be recovered. Additionally, for each temporal version 801, 803, 805, 807, 809, 811, the time of the last file modification is provided and an identification as to whether the temporal version is available, networked, obtainable, or at a remote location is included. For example, the temporal version MY WORD 801 indicates that the last modification time of the temporal version copy was Mar. 5, 2005 813, and that the file is available. A file is considered available if it can be obtained from the consumer computer. A file is considered a local networked file if it can be obtained from a locally networked computer.

The temporal version of MY WORD 809 indicates that the recoverable version is a copy of the file as modified on Feb. 21, 2005, at 8:00 a.m., and that it was backed up to a DVD/CD on Feb. 22, 2005, at 8:35 a.m., to (Disk 6) 817. A file located on a removable media, such as a CD or DVD or any other type of randomly accessible media, is considered obtainable if it is maintained locally. The temporal version of MY WORD 811 indicates that the recoverable version is a copy of the file as modified on Feb. 10, 2005, at 8:00 a.m. 819, and that it was backed up to a remote location on Feb. 11, 2005, at 2:00 a.m. 821. As will be appreciated by one of ordinary skill in the relevant art, the pictorial diagram illustrated in FIG. 8 is provided for explanation purposes and, in alternative embodiments, additional or less information may be presented. For example, the protection copy of MY WORD 811 may only indicate that it is a copy of the file as modified on Feb. 10, 2005, at 8:00 a.m. 819, and not provide any information as to when the backup copy was actually created and/or transferred.

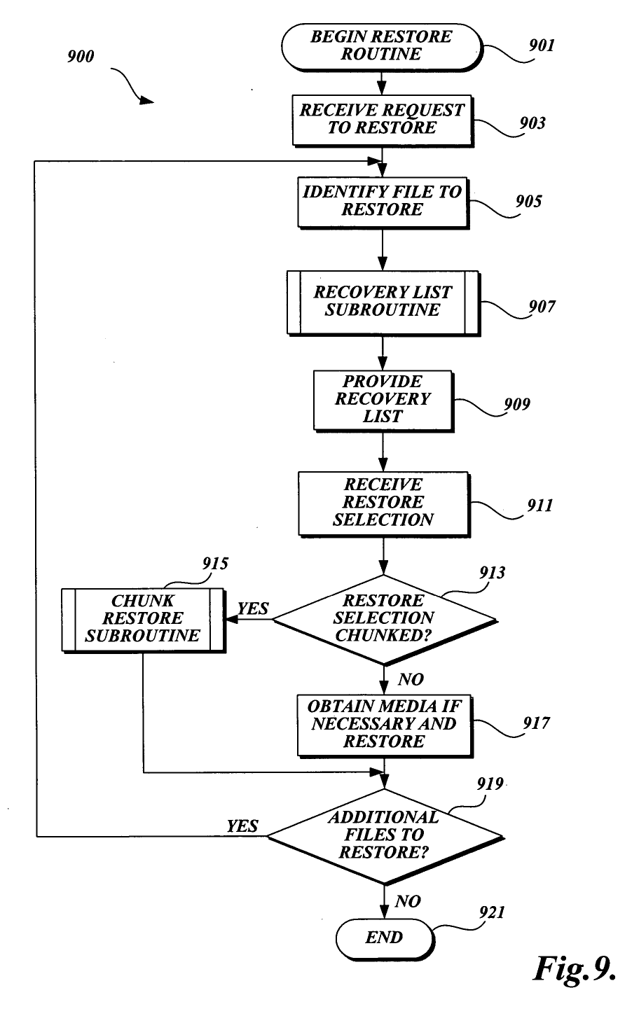

FIG. 9 is a flow diagram of a restore routine for restoring files from protection copies contained in temporal versions, in accordance with an embodiment of the present invention. The restore routine 900 begins at block 901, and at block 903, a restore request is received. A restore request may be a request to restore a single file, multiple files, a single directory, multiple directories, an entire volume, particular file types, files created or modified on a particular day, etc.

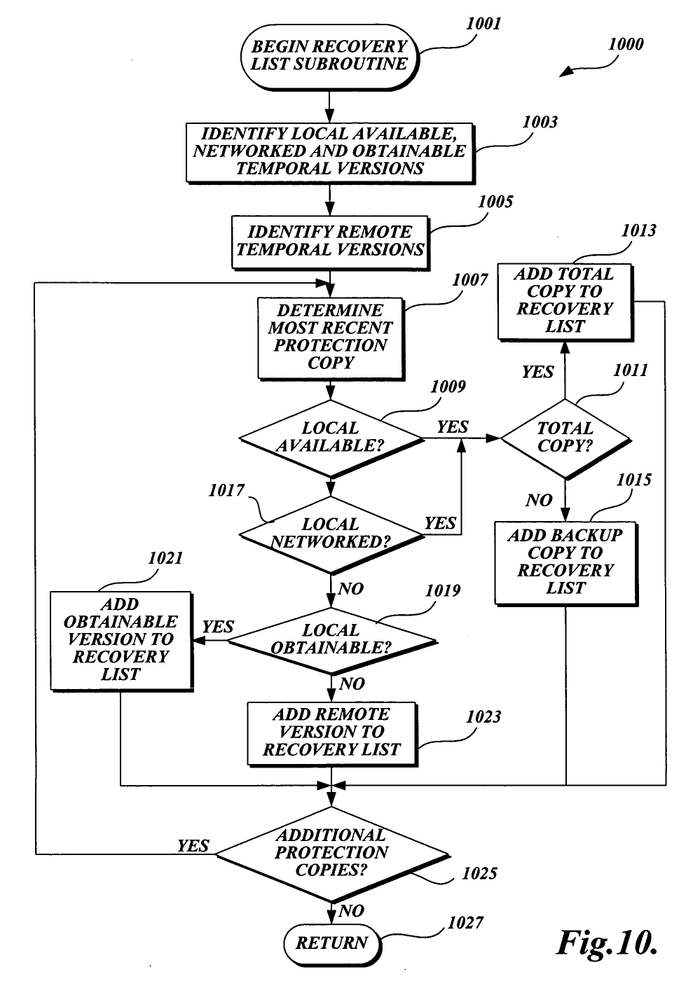

At block 905, the routine 900 identifies a file to restore and at subroutine block 907, the recover list subroutine is performed, as described in more detail with respect to FIG. 10. In general, the recovery list subroutine generates a list (FIG. 8) identifying different versions of the file that can be recovered. Upon completion of the recovery list subroutine, at block 909, the list returned from that subroutine is provided to a consumer.

The consumer may then pick the version of the file to be recovered from the list and the routine receives such a selection, as illustrated by block 911. Upon receipt of a restore selection, at decision block 913, it is determined whether the restore selection corresponds to a chunked file. As discussed above—because only chunks of a chunked file that are different than stored protection copies of chunks are added to a backup copy—the chunks needed to recover the file to a particular point-in-time may be stored on multiple items of media, all of which are identified in the chunk assembly list. Likewise, files that are not chunked may also be stored on multiple items of media.

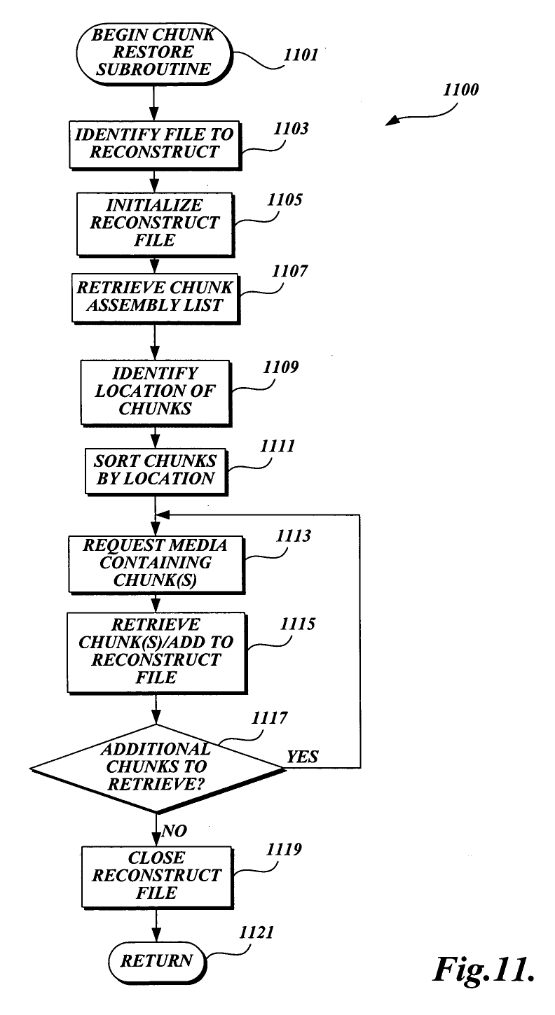

If it is determined that the recovery selection is a chunked file, the chunk restore subroutine is performed, as illustrated by subroutine block 915, and described in more detail with respect to FIG. 11. However, if it is determined that the file is not a chunked file, at block 917, the media containing the protection copy of the file to be recovered is obtained, if necessary, and the file is restored using the protection copy. For example, if the protection copy is stored on a removable media, the routine 900 will provide a consumer with an identification of the item of media, based on a media label maintained in either the master catalog or the appropriate backup catalog. Once the media is obtained, the file is recovered using the protection copy contained in the temporal version stored on the media. If the protection copy of the file being recovered is available, e.g., it is stored on the consumer computer, the media does not need to be obtained.

Once the file is recovered, the routine determines if there are any additional files to recover, as illustrated by decision block 919. If it is determined that there are additional files to recover, the routine returns to block 905 and continues. However, if it is determined at decision block 919 that there are no more files to be recovered, the routine completes, as illustrated by block 921.

While the routine described with respect to FIG. 9 restores a file then determines if there are additional files to restore, in an alternative embodiment, the routine may first identify all files to be restored based on the location of the selected protection copies. For example, if there are four files to be recovered and a protection copy for a first file is on a first item of media, a protection copy for a second file is on a second item, a protection copy for the third file is on a third item of media, and a protection copy for the fourth file is on the second item of media, the files may be organized so that when recovered, the second and third protection copies are obtained sequentially so that the second item of media is only accessed obtained and/or accessed once.

FIG. 10 is a flow diagram of a recovery list subroutine for generating a recovery list identifying different protection copies of a file that is to be recovered, in accordance with an embodiment of the present invention. The recovery list subroutine 1000 begins at block 1001, and at block 1003, local available temporal versions, local networked temporal versions, and local obtainable temporal version that contain a protection copy of the file to be recovered are identified. As discussed above, local available temporal versions include total copies stored on the consumer computer and backup copies stored on the consumer computer. Local networked temporal versions include total copies stored on local networked computers and backup copies stored on local networked computers. Local obtainable temporal versions are temporal versions, such as backup copies, that are maintained locally on removable media. Similarly, at block 1005, the remote temporal versions containing a protection copy of the file to be recovered are identified. As discussed above, the remote temporal versions are temporal versions that are maintained at a remote location.

Temporal versions (local and remote) that include a protection copy of the file to be recovered may be identified in a variety of ways. For example, as discussed above, a master catalog is maintained on the consumer computer that identifies each backup copy, its location, and the contents (protection copies) of that backup copy. Similarly, a backup copy catalog for each backup copy is also maintained both locally and on removable media that identifies, for a particular backup, the contents of that backup. Thus, the backup copies containing protection copies of the file to be recovered can be identified by querying either the master catalog stored on the consumer computer or the backup copy catalogs. Additionally, because total copies include a protection copy of all contents of a volume, it is known that each total copy contains a protection copy of the file to be recovered.

Upon identification of the temporal versions that contain a protection copy of the file to be recovered, as identified by blocks 1003-1005, at block 1007, a most recent point-in-time protection copy of the file to be recovered that is included in the temporal versions is identified.

At decision block 1009 it is determined whether the most recent point-in-time protection copy of the file to be recovered is included in a local available temporal version. If it is determined that the most recent point-in-time protection copy is maintained in a local available temporal version, at decision block 101 1, it is determined if the local available temporal version is a total copy. If it is determined at decision block 1011 that the local available temporal version is a total copy, the protection copy of the file to be recovered included in the total copy is identified in the recovery list, as illustrated by block 1013. However, if it is determined at decision block 1011 that the available temporal version is a backup copy, the protection copy included in the backup copy is identified in the recovery list, as illustrated by block 1015.

Additionally, if there are multiple local available temporal versions created at different times that include the same protection copy of the file to be recovered, only one protection copy from one of the local available temporal versions is selected. In one embodiment, if there are different local available temporal versions taken at different times that include the same protection copy of the file to be recovered, the most recent local available temporal version is selected.

Returning to decision block 1009, if it is determined that the most recent point-in-time protection copy is not contained in a local available temporal version, at decision block 1017, it is determined whether the most recent point-in-time protection copy is contained in a local networked temporal version. If it is determined that the most recent point-in-time protection copy is maintained in a local networked temporal version, at decision block 1011, it is determined if the local networked temporal version is a backup copy. If it is determined at decision block 1011 that the local networked temporal version is not a backup copy (i.e., it is a total copy), the protection copy of the file to be recovered included in the total copy is identified in the recovery list, as illustrated by block 1013. However, if it is determined at decision block 1011 that the local networked temporal version is a backup copy, the protection copy included in the backup copy is identified in the recovery list, as illustrated by block 1015.

Additionally, if there are multiple networked temporal versions created at different times that include the same protection copy of the file to be recovered, only one protection copy from one of the local networked temporal versions is selected. In one embodiment, if there are different local networked temporal versions taken at different times that include the same protection copy of the file to be recovered, the most recent local networked temporal version is selected.

Referring back to decision block 1017, if it is determined that the most recent point-in-time protection copy is not contained in a local networked temporal version, at decision block 1019, it is determined if the most recent point-in-time protection copy is a local obtainable temporal version. If it is determined that the most recent protection copy is a local obtainable temporal version, at block 1021, the protection copy included in the local obtainable copy is identified in the recovery list.

Returning to decision block 1019, if it is determined that the most recent protection copy is not contained in a local obtainable temporal version, at block 1023, the protection copy included in the remote temporal version is identified in the recovery list. At block 1025, it is determined if there are any additional protection copies that have not been listed in the recovery list. If it is determined at decision block 1025 that there are additional protection copies, the subroutine returns control to block 1009 and continues. However, if it is determined that there are no more protection copies to be listed, the subroutine 1000 returns control to the restore routine 900 and completes, as illustrated by block 1027.

The remote temporal version that includes the protection copy added at block 1023 may be either a total copy or a backup copy. In the embodiment illustrated in FIG. 10, the routine 1000 does not determine what type of temporal version is maintained at the remote location and simply adds to the recovery list the protection copy identified by the remote location. However, in an alternative embodiment, if it is determined at decision block 1019 that the local temporal version is not obtainable, the routine 1000 may transition to block 1011 instead of block 1023, and proceed as discussed above. In particular, at decision block 1011, the routine 1000 determines if the remote temporal version is a total copy. If it is determined that the remote temporal version is a total copy, the protection copy included in the total copy is added to the recovery list, as illustrated by block 1013. However, if it is determined at decision block 1011 that the remote temporal version is not a total copy (i.e., it is a backup copy), at block 1015, the protection copy included in the backup copy is added to the recovery list.

In another embodiment, the routine 1000 may, if a protection copy is contained in both a local obtainable temporal version and a remote temporal version, provide the consumer with an option of picking which temporal version should be used to recover the file. Such an option may be beneficial if the consumer, for some reason, is unable to obtain the obtainable temporal versions or if the remote temporal versions are easily accessible.

FIG. 11 is a block diagram illustrating a chunk restore subroutine for restoring files that have been saved in chunks, in accordance with an embodiment of the present invention. As discussed above, when a file is saved in a chunked incremental backup format, each of the chunks may be located on different items of removable media and/or at different locations. For example, the file outlook.ost 201 (FIG. 2A) is a large file, of which only a small portion typically changes between successive backups. As discussed above, temporal versions of chunks are created only for those portions of the file that have changed. Thus, over time, several chunks may be located on different items of media. The chunk restore subroutine 1100 begins at block 1101 and, at block 1103, the file that is to be reconstructed is identified. The file is identified by receiving a file recovery notification from the restore routine 900 (FIG. 9). Upon identification of a file to reconstruct at block 1103, at block 1105, a reconstruct file is initialized to an empty file. At block 1107, a chunk assembly list created during generation and storage of the most recent protection copy of chunk corresponding to the file to be recovered is retrieved. Utilizing the chunk assembly list, at block 1109, the locations of all protection copies of chunks that make up the file to be reconstructed are identified. Upon identification of the locations of all protection copies of chunks necessary for reconstructing an identified file, at block 1111 the protection copies of chunks are sorted based on location. The locations may be, for example, the different items of media on which the protection copies reside. Sorting the protection copies of chunks based on location reduces the number of times a single item of media is requested for access because all protection copies of chunks stored on one item of media may be retrieved at the same time. For example, if a file has five chunks, wherein a protection copy of the first chunk is on a first item of media, a protection copy of the second chunk is on a second item of media, protection copies of the third and fourth chunks are on a third item of media, and a protection copy of the fifth chunk is on a fourth item of media, the protection copies are sorted such that each of the items of media is only obtained and accessed once.

Upon sorting of protection copies of chunks, at block 1113, the routine 1100 provides to the consumer a media request for one of the items of media upon which protection copies of chunks are stored at their target offsets, as specified by the chunk assembly list. At block 1115, upon receiving a requested item of media, the protection copy(ies) stored on that media is retrieved and added to the reconstruct file. Upon retrieval of all protection copies of chunks from the requested item of media, at decision block 1117, a determination is made as to whether there are other protection copies of chunks to be retrieved that are necessary for reconstructing an identified file. If it is determined at decision block 1117 that there are additional protection copies of chunks that need to be retrieved, the subroutine 1100 returns to block 1113 and continues with a request for another item of media. However, if it is determined at decision block 1117 that there are no additional protection copies of chunks to retrieve, at block 1119 the reconstruct file is closed and the subroutine returns control to the restore routine 900 (FIG. 9), as illustrated by block 1121.

While embodiments of the present invention have been illustrated and described, it will be appreciated that various changes can be made therein without departing from the spirit and scope of the invention.

The embodiments of the invention in which an exclusive property or privilege is: claimed are defined as follows:

1. A method for identifying files that are to be included in a backup copy, the method comprising:
identifying a file;
determining, based on a file extension of the identified file, if the identified file is to be excluded from a backup copy;
in response to determining that the identified file is not to be excluded based on the file extension, determining, based on a file location of the identified file, if the identified file is to be excluded from the backup copy; and
in response to determining that the identified file is not to be excluded based on the file location, including the identified file in a backup copy.

2. The method of claim 1, wherein including the identified file in a backup copy includes:
creating a protection copy of the identified file and including the protection copy in the backup copy.

3. The method of claim 1, further comprising:
determining, based on the file extension of the identified file, if the identified file is to be included in the backup copy.

4. The method of claim 3, wherein determining, based on the file extension of the identified file, if the identified file is to be included in the backup copy includes:
determining, based on a heuristic rule associated with a file location of the identified file, if the identified file is to be included in the backup copy.

5. The method of claim 4, wherein the heuristic rule identifies whether the identified file has been modified more recently than a directory containing the identified file.

6. The method of claim 1, wherein determining, based on a file location of the identified file, if the identified file is to be excluded from the backup copy, includes:
determining if a directory containing the file has an exclusion rule;
if it is determined that the directory has an exclusion rule, excluding the file from the backup copy;
if it is determined that the directory does not have an exclusion rule, determining if the directory has an inclusion rule;
if it is determined that the directory has an inclusion rule, including the identified file in the backup copy; and
if it is determined that the directory does not have an inclusion rule, excluding the identified file form the backup copy.

7. In a computer system having a computer-readable medium including a computer-executable program therein for performing the method of creating a protection copy of a chunk of a file, wherein a protection copy of the file has previously been created, the method comprising:
identifying a file that is to be protected;
partitioning the identified file into a plurality of chunks;
determining if a chunk matches a previous protection copy of a chunk;
if it is determined that the chunk does not match a previous protection copy of a chunk, creating a protection copy of the chunk; and
generating a chunk assembly list.

8. The computer system of claim 7, wherein determining if a chunk matches a previous protection copy of a chunk includes:
generating a chunk signature for the chunk;
comparing the generated chunk signature with a chunk signature of a previous protection copy of a chunk; and
if the generated chunk signature and the chunk signature of the previous protection copy of a chunk are different, determining that a temporal version of the chunk is to be created.

9. The computer system of claim 7, wherein the protection copy of the chunk is maintained at a location local to the file.

10. The computer system of claim 7, wherein the protection copy of the chunk is stored on a removable media.

11. The computer system of claim 7, wherein the chunk assembly list identifies the location of the protection copy of the chunk and an identification of a location of the previously created protection copy of the file.

12. The computer system of claim 7, wherein the chunk assembly list includes information for restoring the file from created protection copies of chunks.

13. The computer system of claim 7, wherein the protection copy of the chunk is maintained on a first item of media and the previously created protection copy of the file is maintained on a second item of media.

14. In a user backup system having a remote storage location, a computer with a nonremovable storage medium, a removable storage media, and a method for restoring a file, the method comprising:
identifying a plurality of protection copies of the file contained in a plurality of temporal versions, wherein a first temporal version is a local temporal version and wherein a second temporal version is a remote temporal version;
generating a list including an identification of a first protection copy of the file contained in the first temporal version and an identification of a second protection copy of the file contained in the second temporal version;
receiving a selection of an identified protection copy of the file from the generated list;
obtaining the temporal version associated with the selected option; and
recovering the file.

15. The user backup system of claim 14, further comprising:
determining if any of the plurality of temporal versions includes a same protection copy of the file; and
wherein the generated list does not include an identification of any remote temporal versions that include a same protection copy of the file as a local temporal version.

16. The user backup system of claim 15, wherein the local temporal versions may be local available temporal versions, local networked temporal versions, or local obtainable temporal versions.

17. The user backup system of claim 16, wherein the local obtainable temporal versions are stored on removable media.

18. The user backup system of claim 17, wherein the removable media is randomly accessible media.

19. The user backup system of claim 14, wherein the identified local temporal versions include a plurality backup copies that contain protection copies of the file, wherein each of the plurality of backup copies is located on separate items of removable media.

20. The user backup system of claim 14, wherein the remote temporal version identifies a location and timestamp for the protection copy of the file contained in the remote temporal version.
